(19) United States
(12) Patent Application Publication
(10) Pub. No.: US 2005/0131876 A1
(43) Pub. Date: Jun. 16, 2005

(54) Graphical user interface for capture system

(76) Inventors: Ratinder Paul Singh Ahuja, Saratoga, CA (US); Kim Getgen, San Francisco, CA (US); Donald Massaro, Atherton, CA (US); Shaun Coleman, Saratoga, CA (US); Ashish Khasgiwala, Cupertino, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/816,422

(22) Filed: Mar. 31, 2004

Related U.S. Application Data
(60) Provisional application No. 60/528,632, filed on Dec. 10, 2003.

(51) Int. Cl. G06F 17/30

(52) U.S. Cl. 707/3

(57) ABSTRACT

In one embodiment, objects captured over a network can be queried using a graphical user interface. In one embodiment, the graphical user interface (GUI) includes a search editor to enable a user to author and edit a search that mines objects captured by a capture system. In one embodiment, the graphical user also includes a capture rule editor a to enable a user to author and edit a capture rule used by the capture system to intercept objects transmitted over a network.

### PRIORITY AND RELATED APPLICATIONS

This patent application is related to, incorporates by reference, and claims the priority benefit of U.S. Provisional Application 60/528,632, entitled “GRAPHICAL USER INTERFACE FOR DATA CAPTURE AND ANALYSIS SYSTEM”, filed Dec. 10, 2003.

### FIELD OF THE INVENTION

The present invention relates to computer networks, and in particular, to a graphical user interface for a capture system.

### BACKGROUND

Computer networks and systems have become indispensable tools for modern business. Modern enterprises use such networks for communications and for storage. The information and data stored on the network of a business enterprise is often a highly valuable asset. Modern enterprises use numerous tools to keep outsiders, intruders, and unauthorized personnel from accessing valuable information stored on the network. These tools include firewalls, intrusion detection systems, and packet sniffer devices. However, once an intruder has gained access to sensitive content, there is no network device that can prevent the electronic transmission of the content from the network to outside the network. Similarly, there is no network device that can analyse the data leaving the network to monitor for policy violations, and make it possible to track down information leeks. What is needed is a comprehensive system to capture, store, and analyse all data communicated using the enterprises network.

### SUMMARY OF THE INVENTION

In one embodiment, objects captured over a network can be queried using a graphical user interface. In one embodiment, the graphical user interface (GUI) includes a search editor to enable a user to author and edit a search that mines objects captured by a capture system. In one embodiment, the graphical user also includes a capture rule editor a to enable a user to author and edit a capture rule used by the capture system to intercept objects transmitted over a network.

### BRIEF DESCRIPTION OF THE DRAWINGS

The present invention is illustrated by way of example, and not by way of limitation, in the figures of the accompanying drawings in which like reference numerals refer to similar elements and in which:

FIG. 1 is a block diagram illustrating a computer network connected to the Internet;

FIG. 2 is a block diagram illustrating one configuration of a capture system according to one embodiment of the present invention;

FIG. 3 is a block diagram illustrating the capture system according to one embodiment of the present invention;

FIG. 4 is a block diagram illustrating an object assembly module according to one embodiment of the present invention;

FIG. 5 is a block diagram illustrating an object store module according to one embodiment of the present invention;

FIG. 6 is a block diagram illustrating an example hardware architecture for a capture system according to one embodiment of the present invention;

FIG. 7 illustrates a login view according to one embodiment of the present invention;

FIG. 8 illustrates a home view according to one embodiment of the present invention;

FIG. 9 illustrates a statistical view according to one embodiment of the present invention;

FIG. 10 illustrates a search view according to one embodiment of the present invention;

FIG. 11 illustrates a search editor according to one embodiment of the present invention;

FIG. 12 illustrates a mail view of the search editor according to one embodiment of the present invention;

FIG. 13 illustrates an images view of the search editor according to one embodiment of the present invention;

FIG. 14 illustrates an FTP view of the search editor according to one embodiment of the present invention;

FIG. 15 illustrates a search scheduler according to one embodiment of the present invention;

FIG. 16 illustrates a results view according to one embodiment of the present invention; and

FIG. 17 illustrates a capture rule editor according to one embodiment of the present invention.

### DETAILED DESCRIPTION

Although the present system will be discussed with reference to various illustrated examples, these examples should not be read to limit the broader spirit and scope of the present invention. Some portions of the detailed description that follows are presented in terms of algorithms and symbolic representations of operations on data within a computer memory. These algorithmic descriptions and representations are the means used by those skilled in the computer science arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated.

It has proven convenient at times, principally for reasons of common usage, to refer to these signals as bits, values, elements, symbols, characters, terms, numbers or the like. It should be borne in mind, however, that all of these and similar terms are to be associated with the appropriate physical quantities and are merely convenient labels applied to these quantities. Unless specifically stated otherwise, it will be appreciated that throughout the description of the present invention, use of terms such as “processing”, “computing”, “calculating”, “determining”, “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

As indicated above, one embodiment of the present invention is instantiated in computer software, that is, computer readable instructions, which, when executed by one or more computer processors/systems, instruct the processors/systems to perform the designated actions. Such computer software may be resident in one or more computer readable media, such as hard drives, CD-ROMs, DVD-ROMs, read-only memory, read-write memory and so on. Such software may be distributed on one or more of these media, or may be made available for download across one or more computer networks (e.g., the Internet). Regardless of the format, the computer programming, rendering and processing techniques discussed herein are simply examples of the types of programming, rendering and processing techniques that may be used to implement aspects of the present invention. These examples should in no way limit the present invention, which is best understood with reference to the claims that follow this description.

Networks

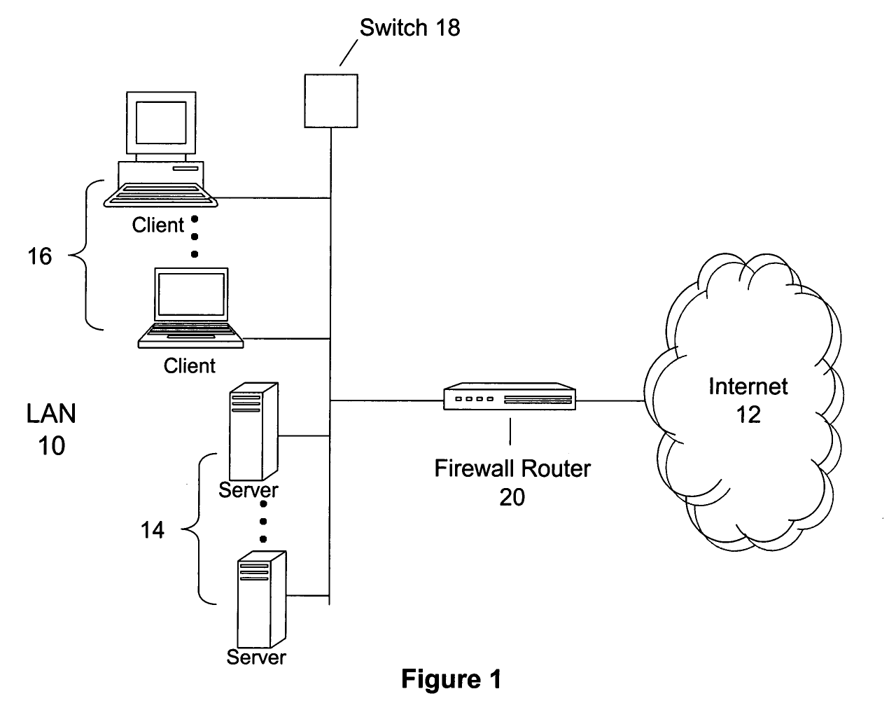

FIG. 1 illustrates a simple prior art configuration of a local area network (LAN) 10 connected to the Internet 12. Connected to the LAN 102 are various components, such as servers 14, clients 16, and switch 18. There are numerous other known networking components and computing devices that can be connected to the LAN 10. The LAN 10 can be implemented using various wireline or wireless technologies, such as Ethernet and 802.11b. The LAN 10 may be much more complex than the simplified diagram in FIG. 1, and may be connected to other LANs as well.

In FIG. 1, the LAN 10 is connected to the Internet 12 via a router 20. This router 20 can be used to implement a firewall, which are widely used to give users of the LAN 10 secure access to the Internet 12 as well as to separate a company's public Web server (can be one of the servers 14) from its internal network, i.e., LAN 10. In one embodiment, any data leaving the LAN 10 towards the Internet 12 must pass through the router 12. However, there the router 20 merely forwards packets to the Internet 12. The router 20 cannot capture, analyse, and searchably store the content contained in the forwarded packets.

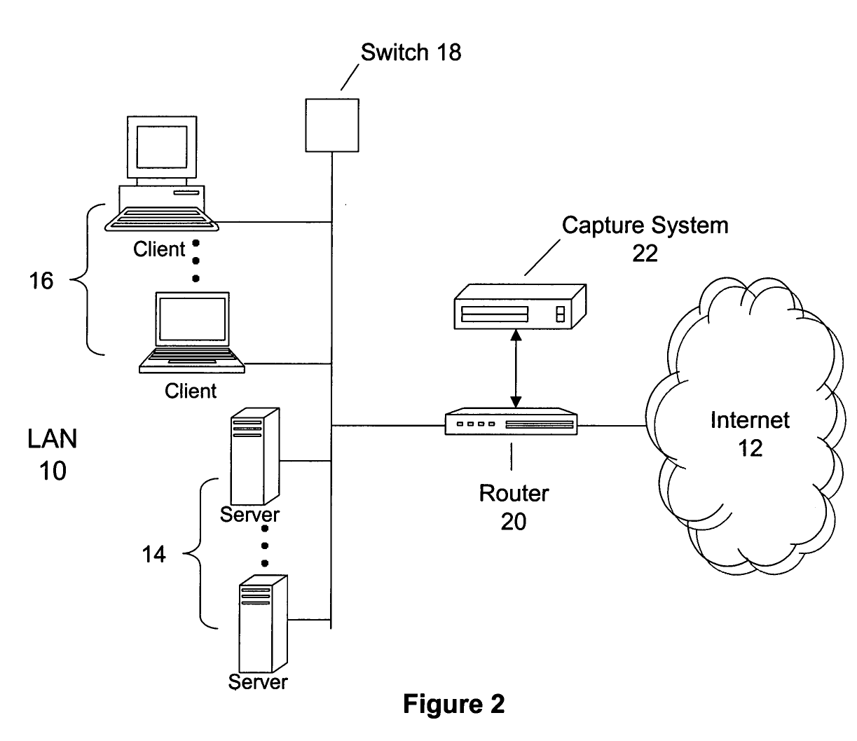

One embodiment of the present invention is now illustrated with reference to FIG. 2. FIG. 2 shows the same simplified configuration of connecting the LAN 10 to the Internet 12 via the router 20. However, in FIG. 2, the router 20 is also connected to a capture system 22. In one embodiment, the router 12 splits the outgoing data stream, and forwards one copy to the Internet 12 and the other copy to the capture system 22.

There are various other possible configurations. For example, the router 12 can also forward a copy of all incoming data to the capture system 22 as well. Furthermore, the capture system 22 can be configured sequentially in front of, or behind the router 20, however this makes the capture system 22 a critical component in connecting to the Internet 12. In systems where a router 12 is not used at all, the capture system can be interposed directly between the LAN 10 and the Internet 12. In one embodiment, the capture system 22 has a user interface accessible from a LAN-attached device, such as a client 16.

In one embodiment, the capture system 22 intercepts all data leaving the network. In other embodiments, the capture system can also intercept all data being communicated inside the network 10. In one embodiment, the capture system 22 reconstructs the documents leaving the network 10, and stores them in a searchable fashion. The capture system 22 can then be used to search and sort through all documents that have left the network 10. There are many reasons such documents may be of interest, including network security reasons, intellectual property concerns, corporate governance regulations, and other corporate policy concerns.

Capture System

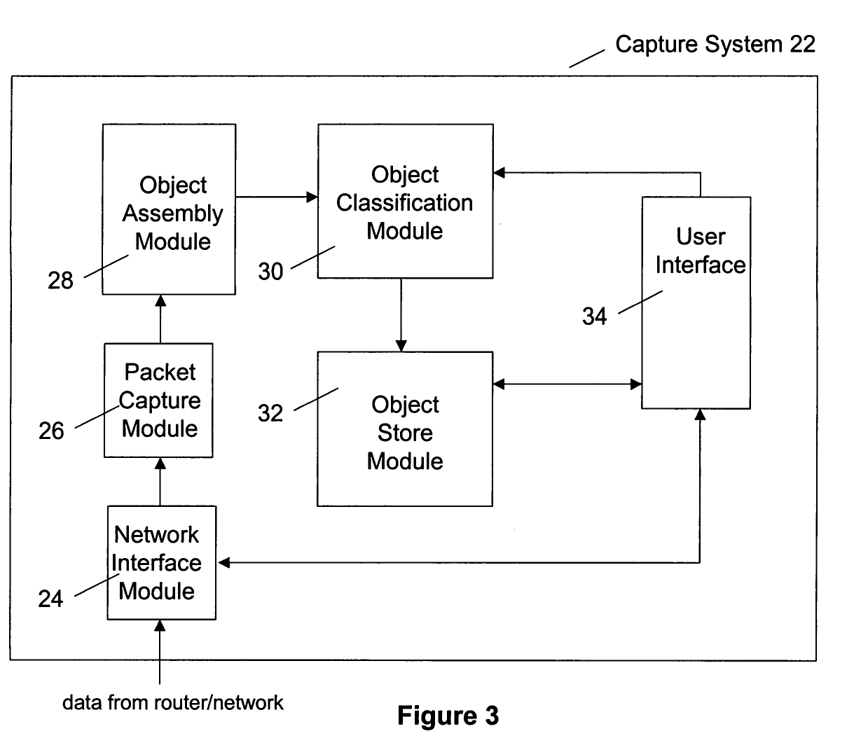

One embodiment of the present invention is now described with reference to FIG. 3. FIG. 3 shows one embodiment of the capture system 22 in more detail. The capture system 22 includes a network interface module 24 to receive the data from the network 10 or the router 20. In one embodiment, the network interface module 24 is implemented using one or more network interface cards (NIC), e.g., Ethernet cards. In one embodiment, the router 20 delivers all data leaving the network to the network interface module 24.

The captured raw data is then passed to a packet capture module 26. In one embodiment, the packet capture module 26 extracts data packets from the data stream received from the network interface module 24. In one embodiment, the packet capture module 26 reconstructs Ethernet packets from multiple sources to multiple destinations for the raw data stream.

In one embodiment, the packets are then provided the object assembly module 28. The object assembly module 28 reconstructs the objects being transmitted by the packets. For example, when a document is transmitted, e.g. as an email attachment, it is broken down into packets according to various data transfer protocols such as Transmission Control Protocol/internet Protocol (TCP/IP) and Ethernet. The object assembly module 28 can reconstruct the document from the captured packets.

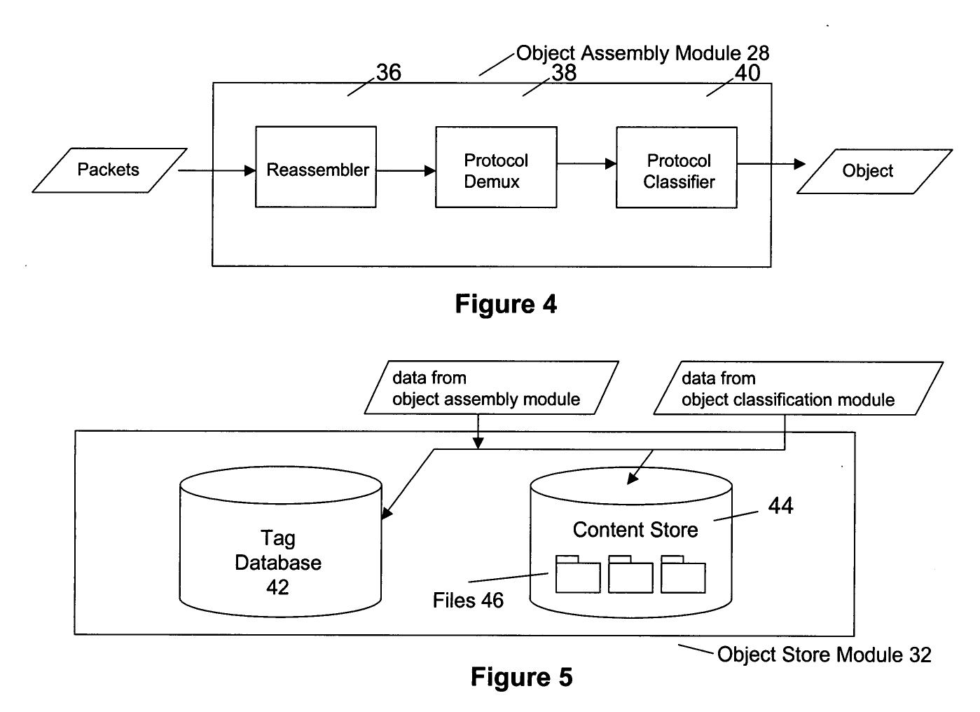

One embodiment of the object assembly module 28 is now described in more detail with reference to FIG. 4. When packets first enter the object assembly module, they are first provided to a reassembler 36. In one embodiment, the reassembler 36 groups—assembles—the packets into unique flows. For example, a flow can be defined as packets with identical Source IP and Destination IP addresses as well as identical TCP Source and Destination Ports. That is, the reassembler 36 can organize a packet stream by sender and recipient.

In one embodiment, the reassembler 36 begins a new flow upon the observation of a starting packet defined by the data transfer protocol. For a TCP/IP embodiment, the starting packet is generally referred to as the “SYN” packet. The flow can terminate upon observation of a finishing packet, e.g., a “Reset” or “FIN” packet in TCP/IP. If now finishing packet is observed by the reassembler 36 within some time constraint, it can terminate the flow via a timeout mechanism. In an embodiment using the TPC protocol, a TCP flow contains an ordered sequence of packets that can be assembled into a contiguous data stream by the ressembler 36. Thus, in one embodiment, a flow is an ordered data stream of a single communication between a source and a destination.

The flown assembled by the reassember 36 can then be provided to a protocol demultiplexer (demux) 38. In one embodiment, the protocol demux 38 sorts assembled flows using the TCP Ports. This can include performing a speculative classification of the flow contents based on the association of well-known port numbers with specified protocols. For example, Web Hyper Text Transfer Protocol (HTTP) packets—i.e., Web traffic—are typically associated with port 80, File Transfer Protocol (FTP) packets with port 20, Kerberos authentication packets with port 88, and so on. Thus in one embodiment, the protocol demux 38 separates all the different protocols in one flow.

In one embodiment, a protocol classifier 40 also sorts the flows in addition to the protocol demux 38. In one embodiment, the protocol classifier 40—operating either in parallel or in sequence with the protocol demux 38—applies signature filters to the flows to attempt to identify the protocol based solely on the transported data. Furthermore, the protocol demux 38 can make a classification decision based on port number which is subsequently overridden by protocol classifier 40. For example, if an individual or program attempted to masquerade an illicit communication (such as file sharing) using an apparently benign port such as port 80 (commonly used for HTTP Web browsing), the protocol classifier 40 would use protocol signatures, i.e., the characteristic data sequences of defined protocols, to verify the speculative classification performed by protocol demux 38.

In one embodiment, the object assembly module 28 outputs each flow organized by protocol, which represent the underlying objects. Referring again to FIG. 3, these objects can then be handed over to the object classification module 30 (sometimes also referred to as the “content classifier”) for classification based on content. A classified flow may still contain multiple content objects depending on the protocol used. For example, protocols such as HTTP (Internet Web Surfing) may contain over 100 objects of any number of content types in a single flow. To deconstruct the flow, each object contained in the flow is individually extracted, and decoded, if necessary, by the object classification module 30.

The object classification module 30 uses the inherent properties and signatures of various documents to determine the content type of each object. For example, a Word document has a signature that is distinct from a PowerPoint document, or an Email document. The object classification module 30 can extract out each individual object and sort them out by such content types. Such classification renders the present invention immune from cases where a malicious user has altered a file extension or other property in an attempt to avoid detection of illicit activity.

In one embodiment, the object classification module 30 determines whether each object should be stored or discarded. In one embodiment, this determination is based on a various capture rules. For example, a capture rule can indicate that Web Traffic should be discarded. Another capture rule can indicate that all PowerPoint documents should be stored, except for ones originating from the CEO's IP address. Such capture rules can be implemented as regular expressions, or by other similar means.

In one embodiment, the capture rules are authored by users of the capture system 22. The capture system 22 is made accessible to any network-connected machine through the network interface module 24 and user interface 34. In one embodiment, the user interface 34 is a graphical user interface providing the user with friendly access to the various features of the capture system 22. For example, the user interface 34 can provide a capture rule authoring tool that allows users to write and implement any capture rule desired, which are then applied by the object classification module 30 when determining whether each object should be stored. The user interface 34 can also provide pre-configured capture rules that the user can select from along with an explanation of the operation of such standard included capture rules. In one embodiment, the default capture rule implemented by the object classification module 30 captures all objects leaving the network 10.

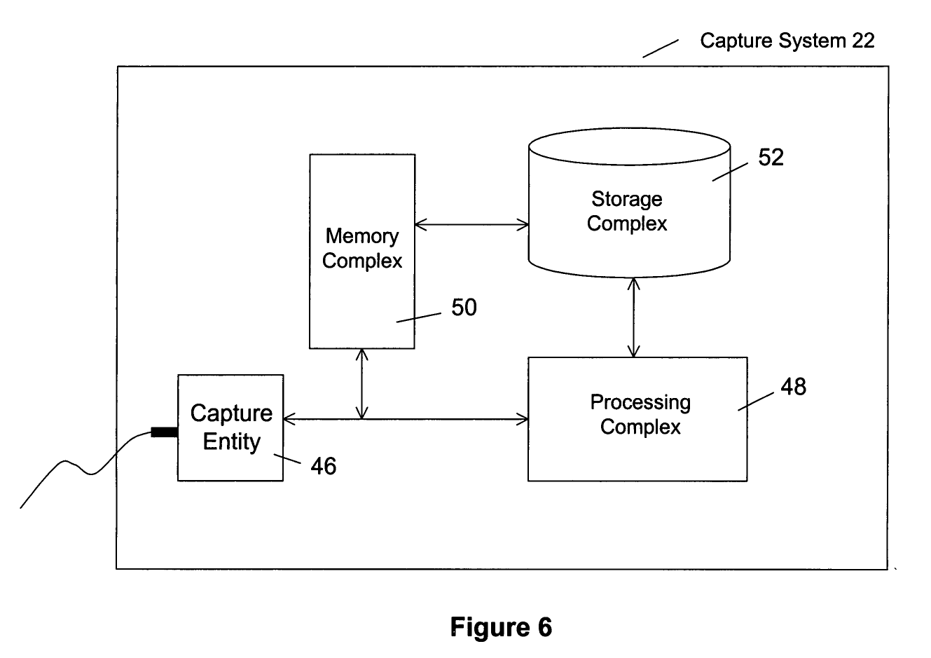

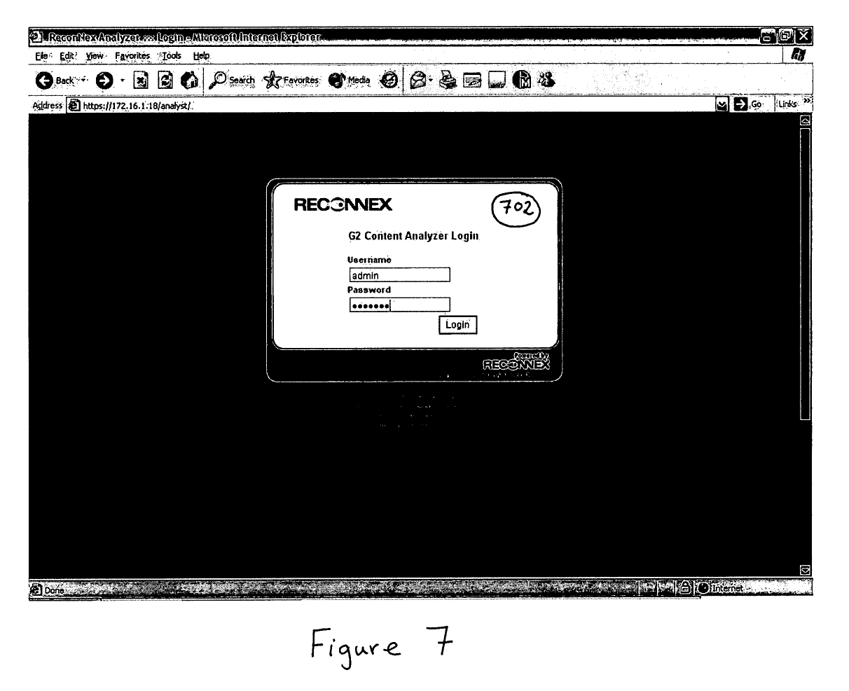

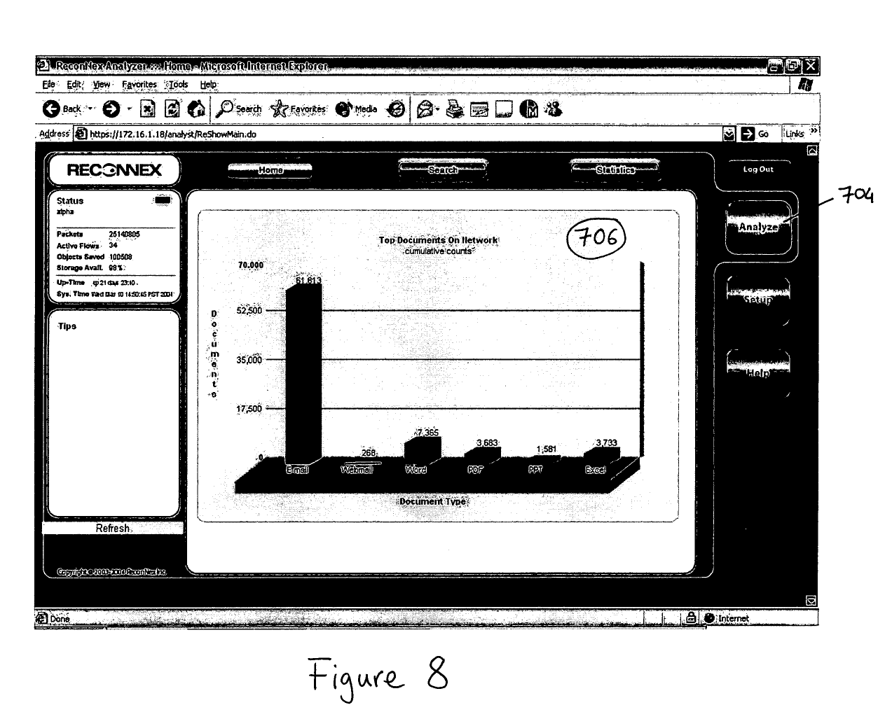

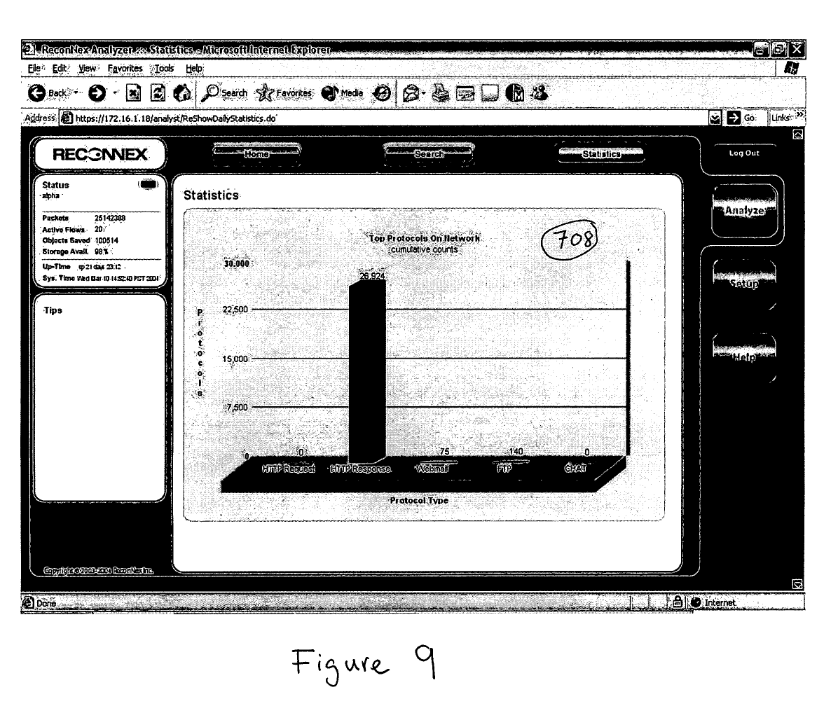

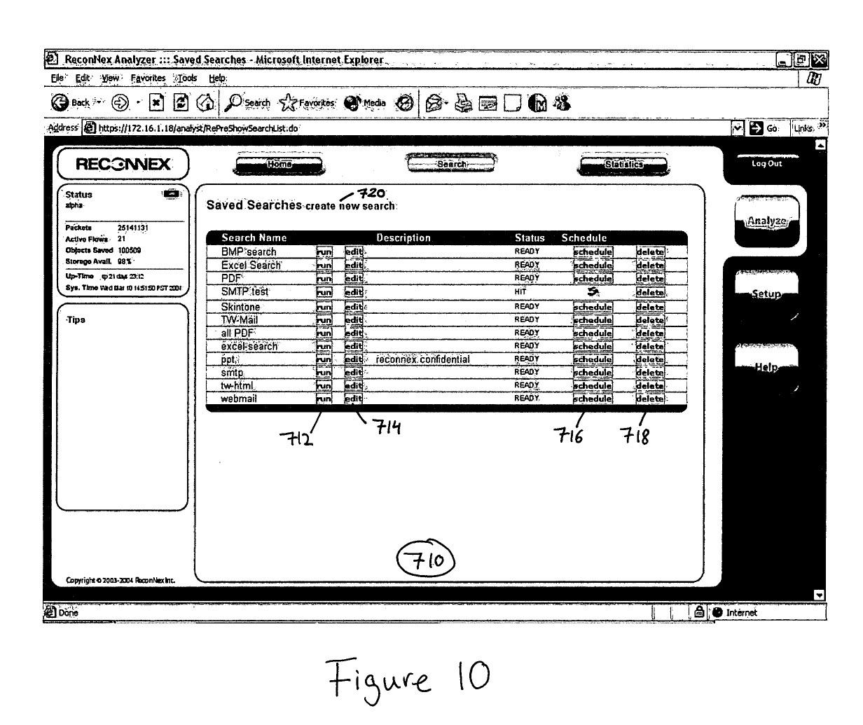

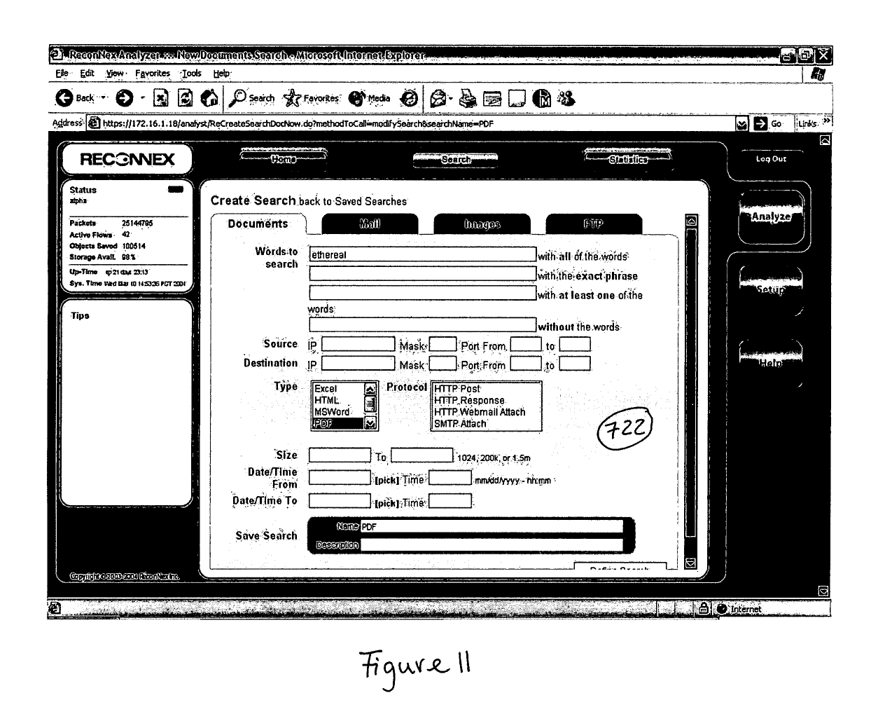

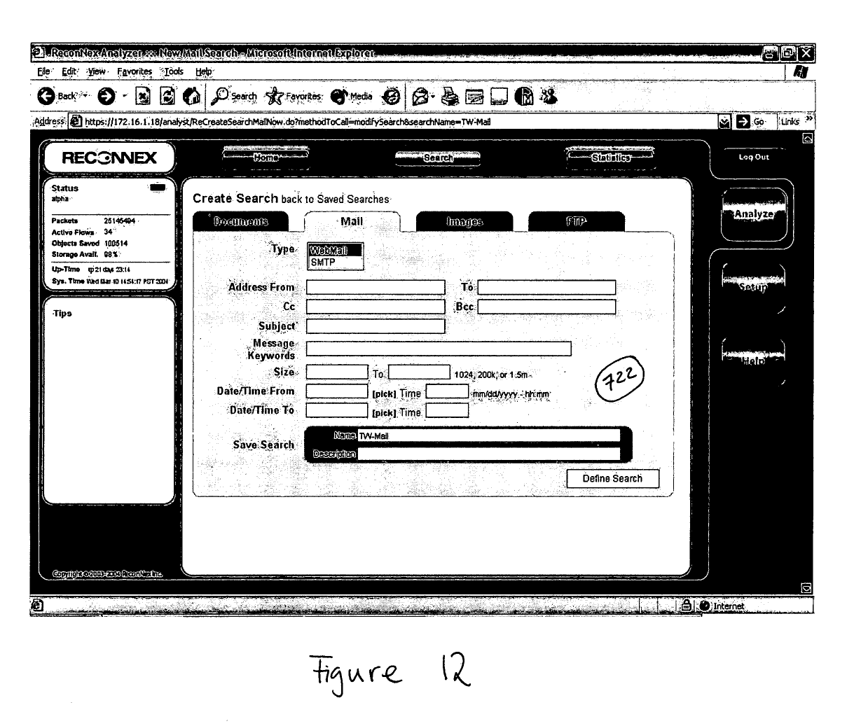

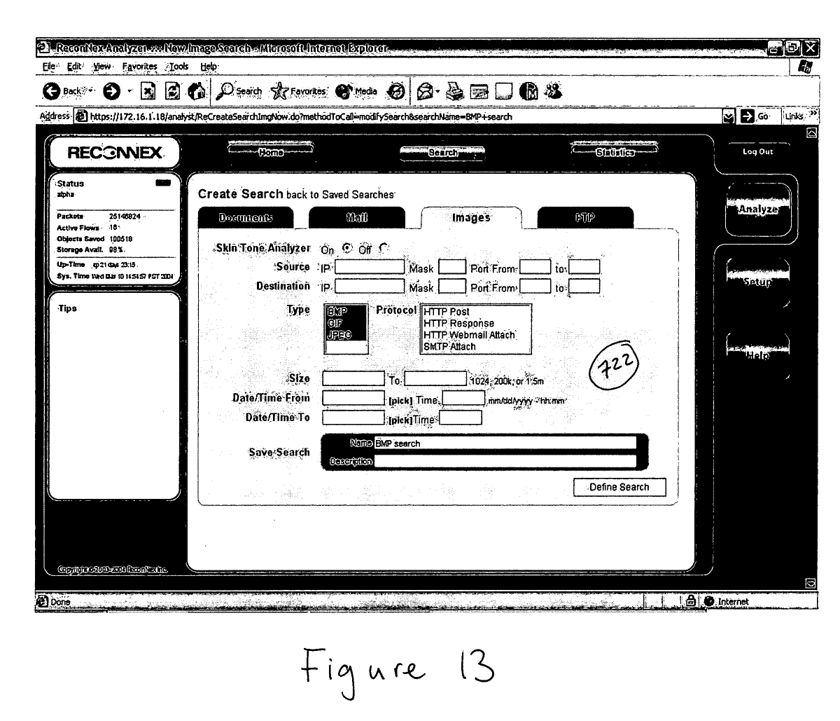

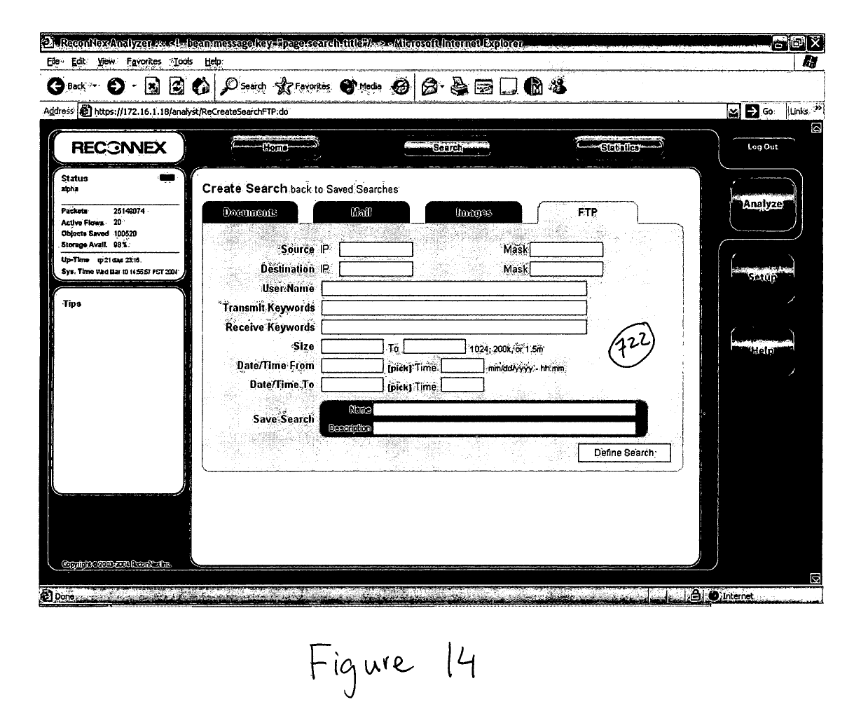

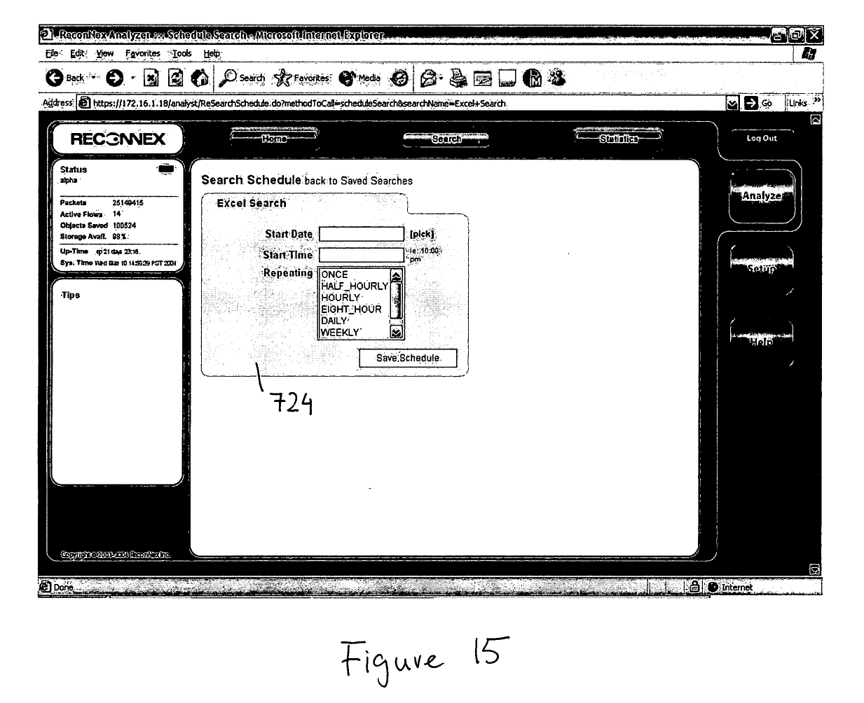

If the capture of an object is mandated by the capture rules, the object classification module 30 can also determine where in the object store module 32 the captured object should be stored. With reference to FIG. 5, in one embodiment, the objects are stored in a content store 44 memory block. Within the content store 44 are files 46 divided up by content type. Thus, for example, if the object classification module determines that an object is a Word document that should be stored, it can store it in the file 46 reserved for Word documents. In one embodiment, the object store module 32 is integrally included in the capture system 22. In other embodiments, the object store module can be external—entirely or in part—using, for example, some network storage technique such as network attached storage (NAS) and storage area network (SAN).

Tag Data Structure

In one embodiment, the content store is a canonical storage location, simply a place to deposit the captured objects. The indexing of the objects stored in the content store 44 is accomplished using a tag database 42. In one embodiment, the tag database 42 is a database data structure in which each record is a “tag” that indexes an object in the content store 44 and contains relevant information about the stored object. An example of a tag record in the tag database 42 that indexes an object stored in the content store 44 is set forth in Table 1:

TABLE 1

| Field Name | Definition |
|---|---|
| MAC Address | Ethernet controller MAC address unique to each |
| | capture system |
| Source IP | Source Ethernet IP Address of object |
| Destination IP | Destination Ethernet IP Address of object |
| Source Port | Source TCP/IP Port number of object |
| Destination Port | Destination TCP/IP Port number of the object |
| Protocol | IP Protocol that carried the object |
| Instance | Canonical count identifying object within a protocol |
| | capable of carrying multiple data within a single |
| | TCP/IP connection |
| Content | Content type of the object |
| Encoding | Encoding used by the protocol carrying object |
| Size | Size of object |
| Timestamp | Time that the object was captured |
| Owner | User requesting the capture of object (rule author) |
| Configuration | Capture rule directing the capture of object |
| Signature | Hash signature of object |
| Tag Signature | Hash signature of all preceding tag fields |

There are various other possible tag fields, and some embodiments can omit numerous tag fields listed in Table 1. In other embodiments, the tag database 42 need not be implemented as a database, and a tag need not be a record. Any data structure capable of indexing an object by storing relational data over the object can be used as a tag data structure. Furthermore, the word “tag” is merely descriptive, other names such as “index” or “relational data store,” would be equally descriptive, as would any other designation performing similar functionality.

The mapping of tags to objects can, in one embodiment, be obtained by using unique combinations of tag fields to construct an object's name. For example, one such possible combination is an ordered list of the Source IP, Destination IP, Source Port, Destination Port, Instance and Timestamp. Many other such combinations including both shorter and longer names are possible. In another embodiment, the tag can contain a pointer to the storage location where the indexed object is stored.

The tag fields shown in Table 1 can be expressed more generally, to emphasize the underlying information indicated by the tag fields in various embodiments. Some of these possible generic tag fields are set forth in Table 2:

TABLE 2

| Field Name | Definition |
|---|---|
| Device Identity | Identifier of capture device |
| Source Address | Origination Address of object |
| Destination Address | Destination Address of object |
| Source Port | Origination Port of object |
| Destination Port | Destination Port of the object |
| Protocol | Protocol that carried the object |
| Instance | Canonical count identifying object within a protocol |
| | capable of carrying multiple data within a single |
| | connection |
| Content | Content type of the object |
| Encoding | Encoding used by the protocol carrying object |
| Size | Size of object |
| Timestamp | Time that the object was captured |
| Owner | User requesting the capture of object (rule author) |
| Configuration | Capture rule directing the capture of object |
| Signature | Signature of object |
| Tag Signature | Signature of all preceding tag fields |

For many of the above tag fields in Tables 1 and 2, the definition adequately describes the relational data contained by each field. For the content field, the types of content that the object can be labelled as are numerous. Some example choices for content types (as determined, in one embodiment, by the object classification module 30) are JPEG, GIF, BMP, TIFF, PNG (for objects containing images in these various formats); Skintone (for objects containing images exposing human skin); PDF, MSWord, Excel, PowerPoint, MSOffice (for objects in these popular application formats); HTML, WebMail, SMTP, FTP (for objects captured in these transmission formats); Telnet, Rlogin, Chat (for communication conducted using these methods); GZIP, ZIP, TAR (for archives or collections of other objects); C++ Source, C Source, FORTRAN Source, Verilog Source (for source or design code authored in these high-level programming languages); C Shell, K Shell, Bash Shell (for shell program scripts); Plaintext (for otherwise unclassified textual objects); Crypto (for objects that have been encrypted or that contain cryptographic elements); Binary Unknown, ASCII Unknown, and Unknown (as catchall categories).

The signature contained in the Signature and Tag Signature fields can be any digest or hash over the object, or some portion thereof. In one embodiment, a well known hash, such as MD5 or SHA1 can be used. In one embodiment, the signature is a digital cryptographic signature. In one embodiment, a digital cryptographic signature is a hash signature that is signed with the private key of the capture system 22. Only the capture system 22 knows its own private key, thus, the integrity of the stored object can be verified by comparing a hash of the stored object to the signature decrypted with the public key of the capture system 22, the private and public keys being a public key cryptosystem key pair. Thus, if a stored object is modified from when it was originally captured, the modification will cause the comparison to fail.

Similarly, the signature over the tag stored in the Tag Signature field can also be a digital cryptographic signature. In such an embodiment, the integrity of the tag can also be verified. In one embodiment, verification of the object using the signature, and the tag using the tag signature is performed whenever an object is presented, e.g., displayed to a user. In one embodiment, if the object or the tag is found to have been compromised, an alarm is generated to alert the user that the object displayed may not be identical to the object originally captured.

Graphical User Interface

One embodiment of the user interface 34 is a graphical user interface (GUI) described in greater detail with reference to FIGS. 7-17. In one embodiment, the GUI enables the user to mine the tag database based on search criteria corresponding to the tag fields. Furthermore, the search criteria can also include other indexed search criteria, such as single dictionary keywords, and non-indexed search criteria, such as word patterns. Thus, in one embodiment, searches (also referred to as mines or queries) can mine both the tag database and the content store.

In one embodiment, a user's identity is verified by requiring a password to log into the system 22. For example, a user can log on via the logon view 702 shown in FIG. 7. In one embodiment, the GUI is configured based on the identity of the user. For example, the username “admin” may belong to the CTO who is only interested in confidential technical documents. The GUI can configure itself to display options relevant to the interests of the CTO.

In one embodiment, after logging on, the GUI displays an analyze view 704 to the user. In analyze view, the user can perform analysis on the objects (also sometimes referred to as documents) captured by the capture system 22. In one embodiment, the GUI also has a setup view 708, which enables the user to control the operation of the capture system 22. The names “analyze” and “setup” are merely descriptive, and their functionalities can be given numerous other descriptive names. For example, the analyze view 704 could be called the “research view,” or the “data mining view,” or any other name, so long as the view enables the user to analyze or search or mine or graph the captured objects.

In one embodiment, the analyze view 704 includes a home view 706 of the monitored network, illustrated in FIG. 8. The home view 706 may include a bar graph or other chart indicating a statistical breakdown of all captured, i.e. intercepted, objects, by object type.

In one embodiment, the analyze view 704 also includes a statistics view 708, illustrated in FIG. 9. The statistics view 708 displays a bar graph of the protocols used to transmit the captured objects. Other graphs can be displayed by the statistics view 708, such as statistical breakdowns of individual users, distributions among users or network segments, and various other statistical data presentation over the captured objects.

In one embodiment, the analyze view 704 also includes a search view 710. In one embodiment, the search view 710 is the tool provided by the GUI to author searches (also referred to as queries or mines), save searches, edit saved searches, schedule searches, and view search results. As illustrated in FIG. 10, the search view 710 displays a list of saved searches. Options are available to run 712 (execute) each search, to edit 714 each search, to schedule 716 or edit the scheduling of each search, to delete 718 each search, or to create a new search 720.

In one embodiment, if the user selects his option to create a new search 720 or to edit a saved search 714, the GUI provides a search editor view 722 to the user, as illustrated by FIGS. 11-14. One embodiment of the search editor 722 illustrated by FIG. 11 is configured to enable the user to create or edit a search for documents. In one embodiment, “documents” is a catchall category for describing objects. The user is provided with various keyword and word pattern search options to specify words and phrases in the stored objects the search is designed to find or avoid. Singe keyword searches may be indexed. Word pattern searches, such as searches for an exact phrase, are generally un-indexed. Thus, in one embodiment, the search editor 722 is configured to input both indexed and non-indexed search criteria to construct a single search.

In addition, in one embodiment illustrated by FIG. 11, the user can also specify other indexed search criteria, such as source and destination IP and port addresses, and masks, and protocol (e.g., HTTP Post, Response or Webmail Attachment, or SMPT Attachment), to define transmission details of the objects of interest. In one embodiment, the user may also select objects by type by selecting from a list of possible document content types, such as the list of document types described with reference to Tables 1 and 2.

The user can further narrow the search by specifying a size range for the objects of interest, and a temporal range for the objects of interest. When the user is finished authoring the search, he can provide a name for the search and save it to the saved searches list shown in FIG. 10. When the user selects to edit 714 an existing document search, the search editor 722 has the saved elements already filled in.

One embodiment of the search editor 722 illustrated by FIG. 12 is configured to enable the user to create or edit a search for electronic mail. The user can select the type of mail used to transmit the objects of interest (e.g., WebMail or SMTP mail). The user may then provide origination, destination, carbon copy, and blind carbon copy addresses of the objects of interest. These search criteria may be indexed. The user is also provided with various keyword and word pattern search options to specify words and phrases in the subject and message portions of the e-mail messages of interest. These search criteria may be non-indexed.

The user can further narrow the search by specifying a size range for the e-mail of interest, and a temporal range to specify when the e-mails of interest may have been sent. When the user is finished authoring the search, he can provide a name for the search and save it to the saved searches list shown in FIG. 10.

One embodiment of the search editor 722 illustrated by FIG. 13 is configured to enable the user to create or edit a search for images. The user is provided with an option to activate a skin tone analyzer for the search. A skin tone analyzer detects images of naked people, and is helpful to catch pornographic images being transmitted on the network. The user can also specify source and destination IP and port addresses, and masks, and protocol, to specify transmission details of the objects of interest. The user may also select the type of image format of interest by selecting from a list of possible image types, such as BMP, GIF, and JPEG.

The user can further narrow the search by specifying a size range for the images of interest, and a temporal range for the images of interest. When the user is finished authoring the search, he can provide a name for the search and save it to the saved searches list shown in FIG. 10.

One embodiment of the search editor 722 illustrated in FIG. 14 is configured to enable the user to create or edit a search for file transfer protocol (FTP) file transfers. The user can specify source and destination IP addresses and masks for the transfers of interest. The user can also indicate the username of the person who executed the FTP transfer. The user can also proved various transmit and receive keywords of interest in the transfer. These keywords can be indexed or non-indexed.

The user can further narrow the search by specifying a size range for the FTP transfers of interest, and a temporal range for the FTP transfers of interest. When the user is finished authoring the search, he can provide a name for the search and save it to the saved searches list shown in FIG. 10.

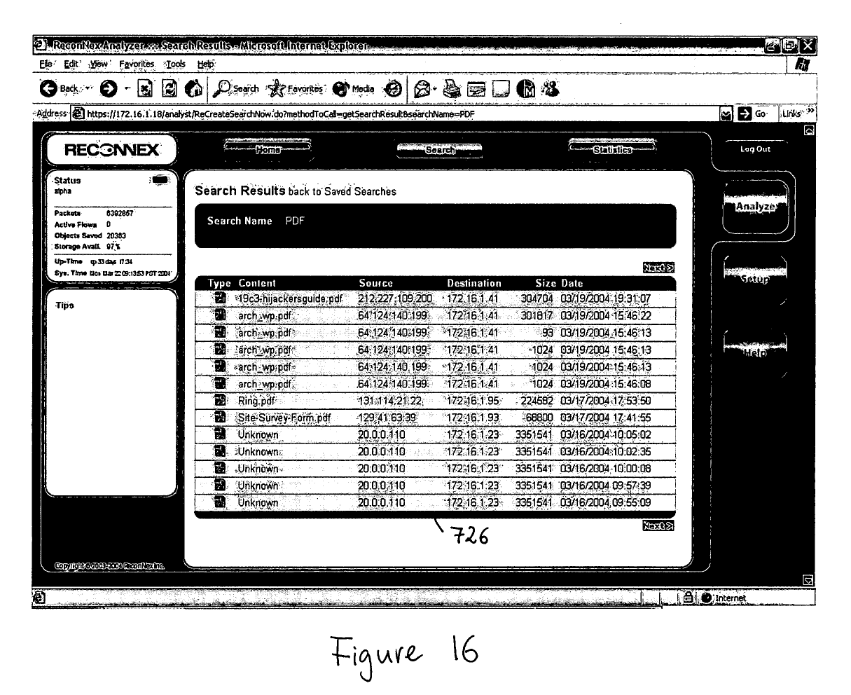

In one embodiment, after a search is created, the GUI provides a search scheduler 724—illustrated by FIG. 15—to enable the user to schedule periodic execution of the search. Thus, a user can periodically receive reports from the capture system 22 based on the saved searches. In one embodiment, the GUI directs the user to the scheduling view 724 if the user selects option 716 in FIG. 10. In one embodiment, the GUI also directs the user to the search scheduler 724 every time a new search is created using the search editor 722 views illustrated in FIGS. 11-14.

In one embodiment, illustrated in FIG. 15, the search scheduler 724 asks the user to specify a start date and time for the first time the search is to be run. In one embodiment, the user is also provided with several scheduling options to choose from indicating the periodic repetition of the search. For example, a search could be scheduled to execute on an hourly bases. Other preset scheduling options can include, immediately, every half hour, every eight hours, once a day, once a week, once a month, once a year, and so on.

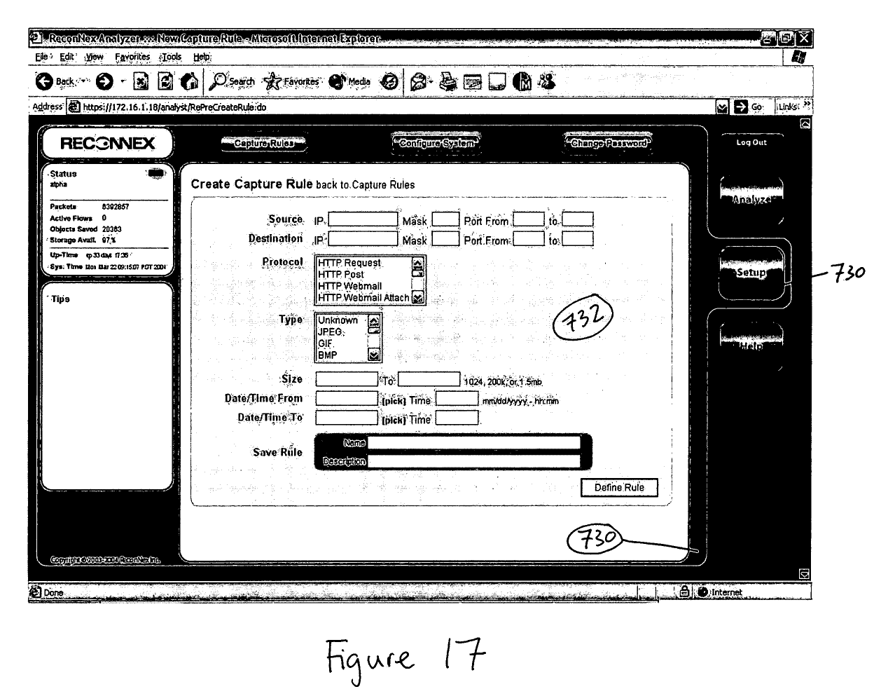

In one embodiment, when a search is executed, i.e., run, its results—the stored objects found according to the search parameters—are displayed in a results view illustrated in FIG. 16. In one embodiment, the results are listed according to various attributes, such as object type (PDF, Word, PowerPoint, Mail, ect.), content, source and destination address, size, and date captured. The results view 726 can order the results according to any such attribute selected by the user.

In one embodiment, the GUI also provides a setup view 730 illustrated in FIG. 17. Unlike the analyze view 710 discussed with reference to FIGS. 8-16 that enable the user to analyze captured objects, the setup view 730 enable the user to change and configure the operation of the capture system 22. In one embodiment, the setup view 730 includes a capture rule editor 732, which allows the user to author capture rules used by the system 22 to decide what intercepted objects to index and store.

In one embodiment, the capture rule editor 732 provides the user view tools similar to the search editor 722 as illustrated in FIG. 11. The user can be provided with various keyword options (not shown) to specify words and phrases that, if they appear in the object, indicate that the object should be captured, i.e., stored. in the stored objects the search is designed to find or avoid. In one embodiment, the user can specify source and destination IP and port addresses, and masks, and protocol, to specify transmission details of the objects the user is interested in capturing. The user may also indicate the types of objects of interest by selecting from a list of possible document types.

The user can further craft the capture rule by specifying a size range for the objects of interest, and a temporal range for the objects of interest. When the user is finished authoring the capture rule, he can provide a name for the rule and save it. In one embodiment, after the rule is saved, it affects how the system 22 captures and stores objects until it is deactivated or deleted. A user can later edit saved capture rules using the capture rule editor 730 as well.

General Matters

In several embodiments, the capture system 22 has been described above as a stand-alone device. However, the capture system of the present invention can be implemented on any appliance capable of capturing and analysing data from a network. For example, the capture system 22 described above could be implemented on one or more of the servers 14 or clients 16 shown in FIG. 1. The capture system 22 can interface with the network 10 in any number of ways, including wirelessly.

In one embodiment, the capture system 22 is an appliance constructed using commonly available computing equipment and storage systems capable of supporting the software requirements. In one embodiment, illustrated by FIG. 6, the hardware consists of a capture entity 46, a processing complex 48 made up of one or more processors, a memory complex 50 made up of one or more memory elements such as RAM and ROM, and storage complex 52, such as a set of one or more hard drives or other digital or analog storage means. In another embodiment, the storage complex 52 is external to the capture system 22, as explained above. In one embodiment, the memory complex stored software consisting of an operating system for the capture system device 22, a capture program, and classification program, a database, a filestore, an analysis engine and a graphical user interface.

Thus, a capture system and a document/content registration system have been described. In the forgoing description, various specific values were given names, such as “objects,” and various specific modules, such as the “registration module” and “signature database” have been described. However, these names are merely to describe and illustrate various aspects of the present invention, and in no way limit the scope of the present invention. Furthermore, various modules, such as the search engine 64 and the notification module 66 in FIG. 8, can be implemented as software or hardware modules, or without dividing their functionalities into modules at all. The present invention is not limited to any modular architecture either in software or in hardware, whether described above or not.

1. A graphical user interface (GUI) for a capture system, the GUI comprising:
a search editor to enable a user to author and edit a search that mines objects captured by the capture system.

2. The GUI of claim 1, wherein the search editor is configured to enable the user to author the search to include both indexed and non-indexed search criteria.

3. The GUI of claim 1, wherein the search editor enables the user to specify one or more of a plurality of search criteria, the search criteria including a content type, a protocol, keywords, and word patterns.

4. The GUI of claim 3, wherein the search criteria further include a source address, a destination address, a size range, and a temporal range.

5. The GUI of claim 1, wherein the search editor enables the user to specify one or more of a plurality of search criteria, the search criteria including an email source, an email destination, and email carbon copy, an email subject, and message keywords.

6. The GUI of claim 1, further comprising a capture rule editor a to enable a user to author and edit a capture rule used by the capture system to intercept objects transmitted over a network.

7. A method comprising:
providing search editing capabilities to allow authoring and editing of a search that mines objects captured by the capture system.

8. The method of claim 7, wherein providing search editing capabilities comprises allowing inputting one or more of a plurality of search criteria, the search criteria including a content type, a protocol, keywords, and word patterns.

9. The method of claim 8, wherein the search criteria further include a source address, a destination address, a size range, and a temporal range.

10. The method of claim 7, wherein providing search editing capabilities comprises allowing inputting one or more of a plurality of search criteria, the search criteria including an email source, an email destination, and email carbon copy, an email subject, and message keywords.

11. The method of claim 7, further comprising providing capture rule editing capabilities to allow authoring and editing of a capture rule used by the capture system to intercept objects transmitted over a network.

12. A system comprising:
means for providing search editing capabilities to allow authoring and editing of a search that mines objects captured by the capture system.

13. The system of claim 12, wherein the means for providing search editing capabilities comprises means for allowing inputting one or more of a plurality of search criteria, the search criteria including a content type, a protocol, keywords, and word patterns.

14. The system of claim 13, wherein the search criteria further include a source address, a destination address, a size range, and a temporal range.

15. The system of claim 12, wherein the means for providing search editing capabilities comprises means for allowing inputting one or more of a plurality of search criteria, the search criteria including an email source, an email destination, and email carbon copy, an email subject, and message keywords.

16. The system of claim 12, further comprising means for providing capture rule editing capabilities to allow authoring and editing of a capture rule used by the capture system to intercept objects transmitted over a network.

17. A computer-readable medium storing data representing instructions that, when executed by a processor, cause the processor to perform operations comprising:
providing search editing capabilities to allow authoring and editing of a search that mines objects captured by the capture system.

18. The computer-readable medium of claim 17, wherein the instruction cause the processor to provide search editing capabilities by allowing inputting one or more of a plurality of search criteria, the search criteria including a content type, a protocol, keywords, and word patterns.

19. The computer-readable medium of claim 18, wherein the search criteria further include a source address, a destination address, a size range, and a temporal range.

20. The computer-readable medium of claim 17, wherein the instructions cause the processor to provide search editing capabilities by allowing inputting one or more of a plurality of search criteria, the search criteria including an email source, an email destination, and email carbon copy, an email subject, and message keywords.

21. The computer-readable medium of claim 17, wherein the instructions further cause the processor to provide capture rule editing capabilities to allow authoring and editing of a capture rule used by the capture system to intercept objects transmitted over a network.
